(19) United States
(12) Patent Application Publication
(10) Pub. No.: US 2008/0067469 A1
(43) Pub. Date: Mar. 20, 2008

(54) Method for Producing Iron Oxide Nano Particles

(75) Inventors: Aharon Eyal, Jerusalem (IL); Asher Vitner, Nayot, Jerusalem (IL)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: JOMA CHEMICAL AS, Limingen (NO)

(21) Appl. No.: 11/571,336

(22) PCT Filed: Jun. 27, 2005
(86) PCT No.: PCT/IL05/00683

§ 371 Date: Aug. 22, 2007

(30) Foreign Application Priority Data
Jun. 27, 2004 (IL) 162742
Mar. 3, 2005 (IL) 167225
Jun. 23, 2005 (IL) 169364

(51) Int. Cl. C01G 49/02

(52) U.S. Cl. 252/182.33; 423/632; 423/633

(57) ABSTRACT

The invention provides a method for the formation of small-size iron oxide particles comprising the steps of preparing a starting aqueous solution comprising at least one of ferric ions and complexes thereof, at a concentration of at least 0.1% W/W iron and a pH greater than about 1.5; maintaining said solution at a temperature lower than 55° C. for a retention time in which hydrolysis takes place, the extent of said hydrolysis being insufficient to decrease the pH by at least 0.2 units, wherein said time does not exceed 14 days, to form a system containing a modified solution; and adjusting the conditions in said system by at least one of the steps of heating the modified solution to elevate the temperature thereof by at least 10° C; elevating the pH of the modified solution by at least 0.3 units; and diluting the modified solution by at least 20%; whereby there are formed particles; wherein the majority of the particles formed are between about 2 nm and about 500 nm in size.

The present invention relates to a method for producing iron oxide nano-particles and more particularly, to a method for producing iron oxide particles of desired particle size, particle size distribution and habit in an industrially and economically useful manner. In the present invention, the term iron oxide means and includes iron oxides of the formula FeₓO_{y} (e.g. Fe₂O₃ as in hematite and magnetite), iron hydroxioxides of the formula Feₚ(OH)_{q}O, (e.g. FeOOH, as in goethite and akaganeite) various hydration forms of those and compositions wherein those are major components, wherein x, y, p, q, r are each whole integers.

Presently iron oxides powders are widely used in industry for various applications: magnetic data storage materials, catalysts, inorganic pigments and precursor for ferrite synthesis. To produce materials with advanced properties (such as nano-crystallinity, narrow particle size distribution, preparation of metastable phases etc.) chemistry techniques, including hydrothermallurgic synthesis, are widely employed. In the case of hydrothermallurgic synthesis of ultra fine iron oxide powders, iron hydroxide, formed in neutral or alkali solutions, is mostly used as a precursor. The preparation of iron (III) oxide from homogeneous acidic solutions at elevated temperature has been noticeably less studied.

Iron oxides come in variety of size, color, density, porosity, surface area and shape. Those parameters have a big impact on their uses and performance. The final product properties depend on the procedures developed for precipitation and aging of the products.

Iron oxide nano-particles exhibit color varying from yellow to yellow brown (limonite and goethite), light red to deep red (hematite), orange (lepidocrotite) and brown (Akaganeite). The color of each iron oxide depends upon particle size, particle size distribution and habit. For example, hematite particles have different colors varying from light red to deep red. Hematite particles having a larger particle size tend to exhibit a deeper hue. For example, the granular hematite particles having an average particle diameter of not more than 200 nm (nanometers) e.g., 50-200 nm, exhibit a light red color, while those having an average particle diameter of 400-600 nm exhibit a deep red color.

Numerous patents dealt with the questions of producing iron oxide particles of definite size, size distribution and habit. For example, in U.S. Pat. No. 6,391,450 (2002) there is described a method to produce spindle-shaped goethite particles and spindle-shaped hematite particles, containing selected amounts of coblat and aluminum which have a uniform particle size, a larger minor axis diameter and a suitable aspect ratio and are very excellent in sintering preventing performance, and to spindle-shaped magnetic iron-based alloy particles which are obtained from said spindle-shaped hematite particles.

In U.S. Pat. No. 5,652,192 relating to catalyst materials and methods of making the same, there is described and claimed a method and apparatus for making nanometer-sized particles, such as iron oxide, titanium oxide, nickel oxide, zirconium oxide, aluminium oxide and silicon oxide by continuously flowing a solution through a heated vessel, and forming particles within the heated vessel by pressurizing and heating said flowing solution to initiate chemicals reactions, followed by quenching of said heated flowing solution and arresting the growth of said solid particles. Said patent envisions production rates of tens of grams of particles per hour to about several kilograms of particles per hour, but does not teach or provide an industrial process capable of producing at least several tens of kilograms of particles per hour.

Numerous studies dealt with heat transformation of iron oxide particles of high hydration level to iron oxide particles of lower hydration level. The result of such transformation is the production of particles of high porosity with crystal habit and size similar to that of the mother particles. The present invention deals with the production of iron oxide particles that can be used as is, but are also of superior qualities concerning their behavior in the transformation reaction.

An object of the present invention is to provide an industrially and economically feasible process for producing iron oxide particles of desired particle size, size distribution and habit. The particles produced in that manner are easy to transform by heating into other iron oxide type particles of lower hydration level thus obtaining particles with high porosity and of the required type, morphology, crystal size, crystal size distribution and habit.

To accomplish this aim, there is provided a process for producing iron oxide particles in aqueous solution, which comprises maintaining an aqueous ferrous salt solution at a temperature lower than 55° C. for a time sufficient to reduce the pH of solution by at least 0.2 pH units due to hydrolysis. The resulting solution is then subjected to a modification in temperature and/or Fe(III) concentration (dilution) and or addition of a reagent thus increasing the pH of the solution. The preferred modification of said parameters is at a high rate.

In a second aspect of the present invention, there is provided raw material for producing other iron oxide particles by heat-transformation of the obtained particles.

More specifically according to the present invention there is now provided a method for the formation of small-size iron oxide particles, comprising the steps of

a) preparing a starting aqueous solution comprising ferric ions or complexes thereof, at a concentration of at least 0.1% w/w iron and at a pH greater than about 1.5.

b) maintaining said solution at a temperature lower than 55° C. for a retention time in which hydrolysis takes place, the extent for said hydrolysis being sufficient to decrease the pH by at least 0.2 units, wherein said time does not exceed 14 days, to form a system containing a modified solution and

c) adjusting the conditions in said system by at least one of the steps of:
i) heating the modified solution to elevate the temperature thereof by at least 10° C.,
ii) elevating the pH of the modified solution by at least 0.3 units; and
iii) diluting the modified solution by at least 20%
   whereby there are formed particles, wherein the majority of the particles formed are between about 2 nm and about 500 nm in size.

In preferred embodiments of the present invention said solution is kept at said modified conditions for at least 0.5 minute.

Preferably said modification of conditions is carried out over a period of up to 1 hour.

In preferred embodiments of the present invention, said process produces at least 50 kilograms of particles per hour.

Preferably said modification of conditions is carried out at a pressure of up to 100 atmospheres.

In preferred embodiments of the present invention said method is further characterized in that the majority of the formed particles have a degree of crystallinity of less than 50%.

Preferably said method is further characterized in that the size ratio between the smallest and biggest particle of 50% of the formed particles is less than about 10.

In especially preferred embodiments said method is further characterized in that the size ratio between the smallest and biggest particle of 50% of the formed particles is less than about 5.

Preferably said method is further characterized in that the majority of the formed particles are of a configuration other than elongated.

In preferred embodiments of the present invention said method is further characterized in that the majority of the formed particles have a configuration wherein the ratio between one dimension and any other dimension is less than about 3.

In other preferred embodiments of the present invention the majority of the formed particles are of an elongated configuration.

Preferably the majority of the formed particles have a surface area of at least 30 m²/gr.

Preferably the majority of the formed particles have a surface area of at least 100 m²/gr.

In especially preferred embodiments of the present invention said method further comprises the step of

(iv) dehydrating said formed particles at a dehydration temperature in a range between about 60° C. and about 800° C. to form dehydrated particles.

In said preferred embodiments said method preferably further comprises the step of removing part of the water in said particle suspension after said facilitating and prior to, simultaneously with or after said dehydrating.

In said preferred embodiments said dehydrating is preferably conducted under super-atmospheric pressure.

In said preferred embodiments the temperature of said particle suspension is preferably elevated to said dehydrating temperature over a period of up to 2 hours.

In said especially preferred embodiments the majority of the dehydrated particles are preferably of a configuration other than elongated.

In said especially preferred embodiments the majority of the dehydrated particles preferably have a surface area of at least 30 m²/gr.

Preferably said particles are selected from the group consisting of goethite hematite and magnetite.

Especially preferred are particles having the formula of FeOOH.

Also preferred are particles having the formula Fe₂O₃.3H₂O.

In preferred embodiments of the present invention said preparation of an aqueous solution involves oxidation.

Preferably the pH of said aqueous solution is between about 1.0 and about 5 during at least a fraction of said facilitating step.

Especially preferred is a method wherein the pH of said aqueous solution is between about 1.5 and about 4 during at least a fraction of said facilitating step.

Most preferred is a method wherein the pH of said aqueous solution is between about 1.7 and about 2.5 during at least a fraction of said facilitating step.

In preferred embodiments of the present invention said preparation of an aqueous solution involves oxidation of ferrous ions.

Preferably said oxidation uses an oxidant selected from a group consisting of oxygen, hydrogen peroxide, nitric acid and nitrate.

Preferably said oxidation is conducted in a solution comprising sulfuric acid and nitric acid.

In preferred embodiments said oxidation is conducted in a pH lower than about 5.

Preferably said oxidation is chemically or biologically catalyzed.

In preferred embodiments of the present invention said preparation of an aqueous solution involves dissolution of an iron compound.

In said preferred embodiments said iron compound is preferably selected from the group consisting of iron salts, iron oxides, iron hydroxides, iron minerals and combinations thereof.

Preferably said iron compound is selected from the group consisting of iron oxides, iron hydroxides, minerals containing the same and mixtures thereof and said compound is dissolved in an acidic solution comprising an acid selected from the group consisting of sulfuric acid, nitric acid, hydrochloric acid, phosphoric acid, their acidic salts and combinations thereof.

In preferred embodiments of the present invention said prepared aqueous solution comprises an anion selected from the group consisting of sulfate, chloride, nitrate, phosphate and mixtures thereof.

In preferred embodiments of the present invention said modification comprises at least two heating steps.

In said preferred modification step at least one heating step is preferably conducted by contacting with a warmer stream selected from a group consisting of hot aqueous solutions, hot gases and steam.

In preferred embodiments said method preferably further comprises grinding formed particles.

In preferred embodiments said method preferably further comprises screening formed particles.

In preferred embodiments said method preferably further comprises hydrogenating formed particles.

The present invention is also directed to iron oxide particles whenever formed according to the above-defined methods and products of their conversion.

The present invention is further directed to a preparation comprising said particles.

In preferred embodiments of said preparation said particles are preferably dispersed in a liquid, supported on a solid compound or agglomerated to larger particles.

In another aspect of the present invention there is provided a process for the production of a preparation as defined above comprising steps selected from the group consisting of dispersing said particles, addition of a support, heat treatment, mixing, water evaporation and combinations thereof.

In especially preferred embodiments of the present invention said particles and preparations are used in the manufacture of a paint.

In other preferred embodiments of the present invention said particles and preparations are used in the manufacture of a catalyst.

In another preferred embodiment of the present invention there is now provided a method for the formation of small-size iron oxide particles, comprising the steps of

a) preparing a starting aqueous solution comprising at least one of ferric ions and complexes thereof, at a concentration of at least 0.1% w/w iron, which solution has pH of at least 1.2;

b) preparing a modifying aqueous solution of a temperature greater than 80° C.;

c) contacting the starting solution with the modifying solution in a continuous mode in a mixing chamber to form a modified system;

d) removing the modified solution from the mixing chamber in a plug-flow mode, and

which method is characterized in that:
(i) the residence time in a mixing chamber is less than about 1 minute,
(ii) there are formed particles or aggregates thereof, wherein the majority of the particles formed are between about 2 nm and about 500 nm in size; and
(iii) the formed particles comprise FeOOH, Fe₂O₃, Fe(OH)₃, Fe₃O₄ or a combination thereof.

In especially preferred embodiments of the present invention the modified solution stays in mixing chamber for less than 5 seconds and in a more preferred embodiment the modified solution stays in the mixing chamber for less than 1 second.

In preferred embodiments of the present invention, the mixing in the mixing chamber is carried out using the flow rate of the entering solution or by using a mechanical mode of mixing or another mode of mixing.

In preferred embodiments of the present invention the modified solution exits the mixing chamber in a plug flow mode. In a more preferred embodiment the plug flow continues for more then 0.1 second and in a most preferred embodiment the plug flow continues for more then 5 seconds.

In preferred embodiments of the present invention the solution exiting the plug flow enters into a vessel. In a more preferred embodiment of the present invention the solution in the vessel is mixed.

### DETAILED DESCRIPTION OF THE INVENTION

The present invention will now be described in detail below.

First, the process for producing iron oxide particles according to the present invention is described.

The starting aqueous iron salt solution used in the present invention, is preferably an aqueous iron salt solution comprising ferric ions or their complexes at a concentration of at least 0.1% w/w iron and at pH greater than about 1.5.

According to a preferred embodiment, the iron w/w concentration in the starting solution is at least 1%, more preferably at least 5%, most preferably at least 10%. There is no upper limit to the concentration of the starting solution. Yet, according to a preferred embodiment, the concentration is below the saturation level. High viscosity is not desired according to another preferred embodiment. According to a preferred embodiment, the pH of the starting solution is at least 1.7, preferably at least 1.9. According to a particularly preferred embodiment, the pH of the prepared starting solution is acidic or neutral, e.g. as determined by the OH/Fe ratio in the solution. According to a preferred embodiment, that ratio is smaller than 3, more preferably smaller than 2.5. According to a preferred embodiment, the temperature of the prepared starting solution is less than 55° C.

Any source of iron is suitable for preparing the starting solution of the present invention, including various scrap irons such as chopped scrap iron or the like, iron containing ores, fractions of such ores, products of their processing, iron salts or iron containing solutions such as aqueous solution exiting iron containing ores.

According to a preferred embodiment, step (b) is conducted shortly after both the desired concentration and pH are achived. According to another preferred embodiment, the solution used in step (b) was prepared within a short time and does not contain ferric ions or their complexes, which were prepared at different times and then mixed together. For a similar reason, extended preparation time is not desired. According to a preferred embodiment, preparation time is shorter than 20 hours, preferably shorter than 10 hours, most preferably shorter than 2 hours. In cases wherein an older solution exists (e.g. a recycled solution) and is desired to be mixed with a fresh solution to form the starting solution, the older solution is first acid treated, as described hereinafter.

The freshly prepared ferric salt solution may contain any anion, including chloride, sulfate, nitrate phosphate, carboxylate, organic acid anions, and various mixtures thereof, etc. According to a preferred embodiment, the freshly prepared solution comprises ferric sulfate. According to another preferred embodiment, the salt is of an organic acid.

A freshly prepared salt solution for use in the process of the present invention may be a solution that was produced (in natural conditions, such as solutions exiting mines with iron containing ores) or a solution that was prepared by artificial methods including chemical or biological oxidations. Such a solution could be prepared by various methods or their combinations, including dissolution of ferric salts, dissolution of ferrous salts, dissolution of double salts, dissolution of iron oxide-containing ores in an acidic solution, dissolution of scrap iron in oxidizing solutions, such as solutions of ferric salt, nitric acid, etc., leaching of iron-containing minerals, such as pyrite and chalcopirite, etc.

Preparing the aqueous solution is conducted in a single step, according to a preferred embodiment. According to an alternative embodiment, the preparation comprises two or more steps. According to an embodiment, a concentrated solution of ferric salt is prepared, e.g. by dissolution of a salt in water or in an aqueous solution. While momentarily and/or locally, during the dissolution, the required pH and concentration of the starting solution are reached, typically the pH of the formed concentrated solution after at least partial homogenization is lower than desided for the starting solution. According to a preferred embodiment, such momentary reaching the desired conditions is not considered preparation of the starting solution. The pH of the concentrated solution is then brought to the desired level by any suitable means, such as removal of an acid, addition and/or increasing the concentration of a basic compound, or a combination of those. The formation of the starting solution in that case is considered the adjustment of the pH to the selected range, according to a preferred embodiment, and the pH of the starting solution is the one obtained after at least partial homogenization, according to another preferred embodiment. According to still another preferred embodiment, a concentrated solution is prepared and the pH is adjusted to a level that is somewhat lower than desired. The starting solution is then prepared by dilution of the solution, which increases the pH to the desired level. Here again, the pH of the starting solution is the one obtained after at least partial homogenization, according to a preferred embodiment. The same is true for other methods of multi-stage preparation of the starting solution, as e.g. in the case of forming a solution of a ferrous salt and oxidizing it to form a solution of a ferric salt.

In some cases of the present invention, the iron source for the solution may be scrap iron or the like and/or iron (II) and an oxidation step must be performed in order to obtain the ferric solution. Such oxidation may use any known oxidant, such as air, oxygen, hydrogen peroxide, nitric acid and nitrate and their combinations. Oxidation could be done at any temperature and pressure. Typically, elevated temperature and elevated pressure accelerate the oxidation reaction. A biological catalyst, a chemical catalyst or a combination thereof could be used. Complete oxidation is not required and the particles of the invention could be formed from a solution containing both ferric and ferrous ions.

According to a preferred embodiment, the starting solution is freshly prepared. According to another preferred embodiment, the solution does not comprise ions and/or complexes prepared at different times, as in the case of mixing a recycled solution with a freshly prepared one. At pH lower than 1.5, high concentration (e.g. above 10% iron) and low temperatures (e.g. lower than 40° C.), a solution maintains its fresheness for a longer time, and could serve as a stock solution, according to a preferred embodiment. At other conditions, the solution is not considered fresh after a few hours or a few days, according to another preferred embodiment. According to a preferred embodiment, freshness of the solution is regained by acid treatment. Such less fresh solution is acidulated to pH lower than 2.0, preferably to a pH lower than 1.5 and is preferably mixed, agitated or shaken for at least 5 min, before increasing the pH back to above 1.7 to reform a fresh solution. Such reformed fresh solution is mixed with other fresh solution according to a preferred embodiment.

In the next step of the process, the ferric solution is preferably retained at a temperature lower than 55° C. for a retention time that doesn't exceed 10 days. During the retention time, hydrolysis takes place. Preferably, the retention time is sufficient for the pH to decrease by at least 0.2 units due to said hydrolysis. According to another preferred embodiment, the retention time is the time needed to produce at least 1 millimolar H+ (protons) in solution. According to still another preferred embodiment, the retention time is the time required to form in the solution 0.0001 mole of proton ions per mole of Fe(III) in the solution, more preferably 0.001 mole of proton ions per mole of Fe(III) in the solution. In cases wherein a base or a basic compound is added to the solution during the retention time, the retention time is the time that would have been needed to form those amounts of protons with no base addition.

According to a preferred embodiment, the retention time decreases with increasing pH of the prepared solution. Thus, e.g. at pH lower than 2.5, the retention time is preferably from 1 hour to few days. At pH of between 2.5 and 5.0 the retention time is preferably less than 1 day. In cases of varying pH during the retention time, the latter is affected by the maximal pH reached. Typically, retention time decreases with increasing temperature of the solution.

The third step needed in order to achieve the above mode of precipitation, is modifying the conditions of the solution to achieve at least one of an increase in pH and/or temperature and or dilution of the solution.

The modification of conditions is preferably done in a short time and the modified conditions are maintained for a short time. The duration at the modified conditions is less than 24 hours, according to an examplary embodiment, preferably less than 4 hours, more preferably less than 1 hour, most preferably less than 10 minutes. In other preferred embodiments of the present invention, the modification of conditions is conducted within 1 hour, preferably within 10 minutes, more preferably 1 minute.

Increasing the pH in step (c) can be achieved by any known method, such as removal of an acid or addition of or increasing the concentration of a basic compound. Acid removal can be conducted by known methods, such as extraction or distillation. Any basic compound could be added. According to a preferred embodiment, a basic compound is a compound that is more basic than ferric sulfate, as measured by comparing the pH of their equi-molar solutions. Thus, such basic compound, is preferably at least one of an inorganic or organic base or precursor of a base, e.g. an oxide, hydroxide, carbonate, bicarbonate, ammonia, urea, etc. According to another preferred embodiment, the basic compound is ferrous salt such as ferrous sulfate. According to a preferred embodiment, ferrous sulfate is formed in situ by introducing metalic iron. Such methods of increasing pH are also suitable for use in step (a) of preparing the starting solution. According to a preferred embodiment, basic pH is avoided through most of the process, so that pH increase in step (c) is conducted so that during most of the duration of that step, the pH is acidic, or slightly acidic.

According to another preferred embodiment, the solution is diluted in step (c). According to a preferred embodiment, dilution is by at least 20%, more preferably at least 100% most preferably at least 200%.

According to another preferred embodiment, the temperature of the solution is increased. According to a preferred embodiment, temperature is increased by at least 10° C., more preferably at least 30° C. most preferably at least 50° C. Temperature increase can be affected by any known method, such as contact with a hot surface, with hot liquid, with hot vapors, infra-red irradiation, microwaving or a combination of those.

According to another preferred embodiment two or all three of the modifications are conducted sequentially or simultaneously. Thus, according to a preferred embodiment, the basic compound is added to the solution of the ferric salt after the retention time, in an aqueous solution, which also dilutes the ferric salt. According to another preferred embodiment, the solution of the ferric salt is contacted with a diluting solution comprising water and/or an aqueous solution, which is of a temperature greater than the solution of the ferric salt solution by at least 50° C. according to a first preferred embodiment, preferably by at least 100° C. According to an alternative embodiment, the temperature of said diluting solution is between about 100° C. and 250° C., between 100° C. and 180° C. according to a preferred embodiment and between 150° C. and 250° C., according to another preferred embodiment. According to another preferred embodiment, the diluting solution comprises a reagent that interacts with ferric ions, their complexes and/or with particles containing those.

According to still another preferred embodiment, the ferric salt solution after the retention time is combined in step (c) with a second aqueous solution comprising a solute that is more basic than the ferric salt, which second solution is at a temperature greater than the solution of the ferric salt. According to a preferred embodiment, the ferric salt solution and said second solution are mixed, e.g. mechanically, in a suitable equipment that provide for strong mixing to achieve rapidly an homogenous system. In cases where the temperature of at least one of those solutions is above boiling point, the mixing equipment is preferably selected so that it withstands super-atmospheric pressure. According to a preferred embodiment, the mixing is conducted by contacting flowing ferric salt solution with flowing second aqueous solution, e.g. in a plug-flow mode. Preferably, the mixed stream is kept at the formed temperature or at another temperature obtained by cooling or heating for a short duration, less than 1 day according to an examplary embodiment, preferably between 1 and 60 minutes, more preferably between 3 and 15 minutes.

The degree of heating, pH elevation and dilution, when conducted as a single means for modification or in combination, affects the chemical nature of the formed particles. For example, typically, the higher the temperature, the lower is the degree of hydration of the particle components. The crystal form and shape are also affected. Thus, the conditions selected for Example 1, lead to spherical particles.

According to a preferred embodiment, the final product oxide is formed in step (c) of the process. According to another preferred embodiment, the product of step (c) is further processed and transformed to the desired final product. Thus ferric hydroxide in the particles is transformed, according to a preferred embodiment, to goethitie or hematite.

Such further processing comprises heating, according to a preferred embodiment. Preferably heating is to a temperature in the range between about 60° C. and 800° C. According to a preferred embodiment, heating is of a solution comprising the formed particles as obtained in step (c), or after some treatment, e.g. partial removal of water. According to another preferred embodiment, the formed particles are first separated from the solution. The separated particles could be treated as such or after further treatment, e.g. washing and/or drying. Heating in solution is preferably done at a super-atmospheric pressure and in an equipment suitable for such pressure. According to a preferred embodiment, an external pressure is applied. The nature of heating is also a controlling factor, so that the results of gradual heating is in some cases different from rapid heating. According to a preferred embodiment, step (c) and further heating are conduced sequentially, preferably in the same vessel.

The crystal habit of the transformed particles is of the general habit of the origin particles from which it was produced, according to a preferred embodiment. For example rod-like goethite particles can be transformed to elongated hematite particles, or in another embodiment of the present invention amorphous particles with low particle dimension ratio can be transformed to goethite of low particle dimension ratio. In another embodiment of the present invention, agglomerates with rod-like habit or agglomerates of spherical habit can be transformed into goethite or hematite particles with rod-like habit or agglomerates with spherical habit, respectively.

As will be realized the present invention provides conditions for the production of precipitates which are easy to transform as well as providing a transformation product with superior properties.

According to a preferred embodiment, at least one dispersant is present in at least one of the method steps. As used here, the term dispersant means and includes dispersants, surfactants, polymers and Theological agents. Thus, a dispersant is introduced into a solution in which a ferric salt is dissolved or is to be dissolved, or is added to a precursor of the solution, such as a mineral ore, according to a preferred embodiment. According to another preferred embodiment, a dispersant is added to the solution during the retention time or after it. According to an alternative embodiment, a dispersant is added to the solution prior to the adjustment step or after such step. According to still another preferred embodiment, a dispersant is added prior to a transforming step, during such step or after it. According to another preferred embodiment, the process further comprises a step of modifying the concentration and/or the nature of the dispersant during the process and/or another dispersant is added. According to a preferred embodiment, suitable dispersants are compounds having the ability to adsorb on the surface of nanoparticles and/or nuclei. Suitable dispersants include cationic polymers, anionic polymers, nonionic polymers, surfactants poly-ions and their mixtures. In the present specfication the term “dispersant” relates to molecules capable of stabilizing dispersions of the formed particles, and/or modifying the mechanism of formation of the nanoparticles, and/or modifying the structure, properties and size of any species formed during the process of formation of the nanoparticles.

According to a preferred embodiment, said dispersant is selected from a group consisting of polydiallyl dimethyl ammonium chloride, Sodium-carboxy methyl cellulose, poly acrylic acid salts , polyethylene glycol, and commercial dispersants such as Solsperse grade, Efka grades, Disperbyk or Byk grades, Daxad grades and Tamol grades (trade names).

According to a preferred embodiment, the process further comprises a step of ultrasound treating the solution during or after at least one of the process steps.

According to a preferred embodiment, the process further comprises a step of microwave treating the solution during or after at least one of the process steps.

According to another preferred embodiment, further processing comprises reducing iron oxide in the formed particles from Fe(III) to Fe(II) or to metal iron. Reduction is partial according to a preferred embodiment and approaches completion according to another. Any reducing agent could be used, e.g. hydrogen. According to a preferred embodiment, reduction is conducted as a separate step, according to an alternative embodiment, reduction is conducted as part of a process of converting the particles into a final product, such as a catalyst.

According to a preferred embodiment, further processing comprises partially fusing particles to particles of greater size. According to another preferred embodiment, aggregates of the particles are mechanically treated for comminuting.

The product of the present invention, as formed in step (c) or after further transformation, is preferably small-size particles of iron oxide. The particles size is in the range between 2 nm and 500 nm, according to a preferred embodiment. According to another preferred embodiment, the size distribution of the the product particles is narrow so that the size ratio between the smallest and biggest particle of 50% of the formed particles is less than about 10, more preferably less than 5, most preferably less than 3.

Separate particles are formed according to a preferred embodiment. According to another embodiment, the formed particles are at least partially agglomerated.

According to a preferred embodiment, the majority of the formed particles have a degree of crystallinity of less than 50% as determined by X-ray analysis.

According to a preferred embodiment, the shape of the particles formed in step (c) or after further transformation, is elongated, such as in needles, rods or rafts.

According to another preferred embodiment, the particles are spherical or nearly spherical, so that the majority of the formed particles have a configuration wherein the ratio between one dimension and any other dimension is less than about 3.

According to a preferred embodiment, the majority of the formed particles have a surface area of at least 30 m²/gr, more preferably at least 100 m²/gr. High surface area particles of the present invention are suitable for use in catalyst preparation.

The process of the present invention is capable of forming highly pure iron oxide from a precursor of relatively low purity, such as an iron ore, e.g. pyrite or chalcopyrite. According to a preferred embodiment, the purity with regards to other metals of at least 95%, more preferably at least 99%.

According to another preferred embodiment, the iron oxide particles are doped with ions or atoms of other transition metals.

According to a preferred embodiment, the particles are obtained in a form selected from a group consisting of particles dispersed in a liquid, particles supported on a solid compound, particles agglomerated to larger particles, partially fused particles, coated particles, or a combination thereof.

The particles, their preparation and/or products of their conversion are suitable for use in many industrial applications, such as in production of pigments, catalysts, coatings, Thermal coating etc. The particles are used in those and other applications as such, according to a preferred embodiment, further processed, according to another, or formed as part of preparing material for such application, according to still another preferred embodiment.

Many of the processes described in the literature are of lab nature and size, e.g. starting with highly pure precursor, working with highly dilute solution and/or at low volumes and/or rates. The method of the present invention is highly suitable for economically attractive industrial scale production. According to a preferred embodiment, the method is operated at a rate of at least 50 Kg/hour, more preferably at least 500 Kg/hour, most preferably at least 5 tons/hour.

According to a preferred embodiment the pH of the solution drops during the process due to the hydrolysis of the ferric salt and thereby formation of an acid, e.g. sulfuric acid. Such acid is reused according to a preferred embodiment, e.g. for the formation of the ferric salt solution, e.g. in dissolution of an iron-containing mineral. According to another preferred embodiment. The formed acid is partially or fully neutralized during the process, forming thereby a salt of the acid. According to a preferred embodiment, the salt is of industrial use, e.g. as in the case where neutralization is done with ammonia to form ammonium salts suitable for use as fertilizers.

According to an alternative method, at least partially dehydrated small-size iron oxide particles are formed. The method comprises the steps of preparing a starting aqueous solution comprising ferric ions or complexes thereof, at a concentration of at least 0.1% w/w iron, which solution has pH of at least 1.2; preparing a modifying aqueous solution of a temperature greater than 80° C.; contacting the starting solution with the modifying solution to form a modified system and retaining the modified system at a temperature greater than 80° C. for at least 0.5 minute. The majority of the formed particles are between about 2 nm and about 500 nm in size and comprise FeOOH, Fe₂O₃, Fe₃O₄ or a combination thereof.

Preparing the starting solution may use methods similar to those described above. According to a preferred embodiment, the iron concentration in said starting solution is greater than 2%. According to a preferred embodiment, the pH of the starting solution is at least 1.5, more preferred at least 1.7. According to an alternative embodiment, the OH/Fe molar ratio in the starting solution is at least 0.05. According to a preferred embodiment, the temperature of the modifying solution is in the range between 100° C. and 300° C.

At least one of the starting solution and modifying solution comprises according to a preferred embodiment a reagent that is capable of interacting with ferric ions, their complexes or with particles containing those. According to a preferred embodiment said reagent is a dispersants or a basic compounds. Where used, the basic compound is preferably ammonia, ammonium carbonate, ammonium bicarbonate or urea. According to a preferred embodiment, basic pH is avoided in the modified solution. Preferably, the OH/Fe molar ratio in the solution of said modified system is less than 3, more preferably between 0.5 and 2.

The temperature of the modified solution is determined by the temperatures of the starting solution and of the hot modifying solution, by their heat capacity and by their relative amounts. According to a preferred embodiment, the temperature of the modified solution is kept with minimal changes, e.g. with no changes greater than 20° C. According to a preferred embodiment the modified system is retained at that temperature for a duration of between 1 and 30 minutes, more preferably between 3 and 15 minutes.

According to another preferred embodiment, the starting solution is maintained for a preliminary retention time before said contact with the modifying solution. Preferably, during the preliminary retention time the solution is kept at a temperature of less than 55° C. and pH greater than 1.5. The duration of the preliminary retention time is sufficient for the pH to decrease by at least 0.2 units, but does not exceed 14 days, according to a preferred embodiment.

According to a preferred embodiment, the particles formed in the process are subjected to steps selected from a group consisting of dispersing said particles, addition of a support, heat treatment, mixing, water evaporation, spray drying, thermal spraying and a combination thereof.

According to preferred embodiments of the present invention a starting aqueous solution comprising at least one of ferric ions and complexes thereof, at a concentration of at least 0.1% w/w iron, which solution has pH of at least 1.2 is prepared.

A modifying aqueous solution of a temperature greater than 80° C. and the starting solution are contacted in a continuous mode in a mixing chamber to form a modified system. The mixing chamber is built in a way to ensure quick and efficient mixing of the solutions. The modified solution is removed from the mixing chamber in a plug-flow mode. During the plug flow the precipitation is completed or in another preferred embodiment the solution is not exhausted during the plug flow time and the precipitation continues in another vessel.

The mixing in the mixing chamber is preferably carried out using the flow rate of the entering solution or by using mechanical mixing means or another mode of mixing.

In one preferred embodiment, the temperature in the mixing chamber and during the plug flow are similar. In another preferred embodiment the temperature of the solution during the plug flow is higher than in the mixing chamber and in yet another preferred embodiment the temperature of the solution during the plug flow is lower than in the mixing chamber.

In a preferred embodiment of the present invention, the residence time in a mixing chamber is less than about 5 minutes and more preferred is a residence time of less than 1 minute. In an even more preferred embodiment, the residence time in a mixing chamber is less than about 5 seconds and in an especially preferred embodiment the residence time is less than 1 second.

In preferred embodiments of the present invention the solution exiting the plug flow enters into a vessel. In a more preferred embodiment of the present invention the solution in the vessel is mixed.

While the invention will now be described in connection with certain preferred embodiments in the following examples so that aspects thereof may be more fully understood and appreciated, it is not intended to limit the invention to these particular embodiments. On the contrary, it is intended to cover all alternatives, modifications and equivalents as may be included within the scope of the invention as defined by the appended claims. Thus, the following examples which include preferred embodiments will serve to illustrate the practice of this invention, it being understood that the particulars shown are by way of example and for purposes of illustrative discussion of preferred embodiments of the present invention only and are presented in the cause of providing what is believed to be the most useful and readily understood description of formulation procedures as well as of the principles and conceptual aspects of the invention.

### EXAMPLE 1

100 gr fresh solution of 0.25M Fe₂(SO₄)₃ (about 2.8% iron) was prepared by dissolving Fe₂(SO₄)₃ crystals in water and adjusting the pH to 2.3 with ammonia. The solution was kept at 25° C. for an hour. The pH reached was 1.9.

The conditions in the solution were adjusted by adding, while vigorously mechanicaly stirring at 600 rpm, to 900 gr water at 80° C., which dilutes, the solution, heats it and increases it pH. After 10 min, the mixing was stopped. Particles were observed. After settling for 1 hour, the clear liquid phase was removed. The precipitate was washed 3 times with water and then centrifuged.

The obtained material was in the form of ultra fine mono-dispersed powder of Fe(OH)₃. SEM photographs indicate that the particle size is uniform and is about 45 nm with average dimension ratio of about 1.5. The particles had a spherical shape.

### EXAMPLE 2

100 gr fresh solution of 0.25M Fe₂(SO₄)₃ was prepared and retained at 25° C. as in Example 1. The solution was added while vigorously mechanically stirring at 600 rpm to 900 gr water at 122° C. in a pressure vessel at a formed pressure of about 2 atmospheres. After 30 min, the mixing was stopped and particles were observed. The particles suspension was allowed to cool to room temperature and a precipitate was observed. The precipitate was separated and washed 3 times with water and then centrifuged.

The obtained material was in the form of ultra fine mono-dispersed powder of FeOOH. The particles were spherical and with average dimension ratio of about 1.5.

### EXAMPLE 3

The procedure in Example 1 was repeated with one difference. The 900 gr hot water contained 0.1% dispersant—poly(diallyldimethylammonium chloride) (PDAC) with molecular weight range of 200,000 to 300,000. After 10 min, the mixing was stopped. A suspension of particles was observed. The particles did not settle during standing for an hour. Particles were separated by centrifugation and washed as in Example 1. The formed particles are similar to those in Example 1.

### EXAMPLE 4

1000 gr fresh solution of 0.25M Fe₂(SO₄)₃ (about 2.8% iron) was prepared by dissolving Fe₂(SO₄)₃ crystals in water. Ammonia was added to 100 gr samples of the solution to reach NH₃/Fe molar ratio of 1. The solution was kept at 25° C. for various retention times (Tᵣₑₜ).

After the retention time, ach of the formed solutions was mixed with 900gr water, containing—in some of the cases—0.25% dispersant (PDAC) at various temperatures and kept in a Parr unit (high pressure vessel) with vigorous mechanical stirring at 600 rpm. After 5 min, the stirring was stopped. Particles were observed and separated from the solution by centrifugation. The precipitate was washed 3 times with water and then centrifuged.

The obtained material was analyzed for water content by thermo-gravimetric analysis (TGA) and by SEM photographs The results are presented in Table 1.

TABLE 1

| Retension | | | | | | |
|---|---|---|---|---|---|---|
| time | Temp | Dispersant | Particle | Average | Deviation | |
| days | (° C.) | presence | Habit | size nm | (50%)* | Remarks |
| 7 | 150 | No | Uniform | 13 × 53 | (47-60) × (11-16) | Spherical |
| | | | rods | | | aggregates |
| 7 | 150 | Yes | rods | 15.5 × 60 | (57-63) × (13-18) | |
| 14 | 150 | No | Spheres | 13 | 11-15 | Spherical |
| | | | arranged | | | aggregates of |
| | | | in rods | | | 300-600 nm |
| 14 | 150 | Yes | Spheres | 13 | 11-15 | Spherical |
| | | | | | | aggregates of |
| | | | | | | 100-500 nm |

Deviation (50%)* = the particle size range of 50% of the particles around the average size (nm).
*The particles in the samples that do not contain dispersants are condensed in aggregates while those with dispersant are loosely attached to each other

### EXAMPLE 5

1000 gr fresh solution of 25% Fe₂(SO₄)₃ was prepared by dissolving Fe₂(SO₄)₃ crystals in water. Ammonia was added to 100 gr samples of the solution to reach various NH₃/Fe molar ratios. The solutions was kept at 25° C. for various retention times (Tᵣₑₜ).

After the retention time, ach of the solutions was added, to 900 gr water at 85° C., containing 0.1% dispersant (PDAC), while vigorously stirring. After 10 min, the stirring was stopped. Particles were observed. The solution was removed and centrifuged. The precipitate was washed 3 times with water and then centrifuged.

The obtained material was analyzed by SEM photographs The results are presented in Table 2.

TABLE 2

| Initial Fe solution | | | | | | |
|---|---|---|---|---|---|---|
| | Fe₂(SO₄)₃ | Tᵣₑₜ | | | Particle | Size |
| NH₃/Fe | Wt % | min | PDAC | Habit | size | distribution |
| 1.75 | 25 | 13 | + | sphere | 20 | narrow |
| 1.50 | 25 | 13 | + | sphere | 80-100 | narrow |

### COMPARATIVE EXAMPLE A

Three different 25% Fe₂(SO₄)₃ solutions were prepared by mixing several 25% Fe₂(SO₄)₃ solutions of various NH3/Fe ratios and various incubation times.

15 gr of each of the three solutions were added, to 135 gr water at 90° C., while vigorously stirring. After 5 min, the mixing was stopped. Particles were observed in all three cases. The solutions were removed by centrifugation. The precipitates were washed 3 times with water and centrifuged.

The obtained materials were analyzed by SEM photographs. In all cases, the particles were distorted rods of large size distribution.

### EXAMPLE 6

1000 gr fresh solution of 0.21M Fe₂(SO₄) was prepared by dissolving Fe₂(SO₄)₃ crystals in water. Various amounts of ammonia were added to 25 gr samples of the solution as described in Table 3. The solutions were kept at 25° 0.C for varies retention times (Tᵣₑₜ).

225 gr water portions were pumped through a heat exchanger which was placed in an oil bath at 150° C. or 190° C., into a 0.25 ml mixing chamber. 25 gr of each Fe₂(SO₄)₃ solution after retention was simultaneously pumped into the same mixing chamber, where it was mixed with the pre-heated water to form modified solutions. Each of the modified solutions was then flowing through a 50 ml heated tube (placed in the same oil bath) into the Parr unit (high pressure vessel) in which the temperature was kept the same as in the oil bath and mixing chamber. After additional 5 min, the mixing was stopped and the solution was removed from the Parr and cooled. The solution was centrifuged and the clear liquid phase was removed. The precipitate was washed 3 times with water and centrifuged.

The obtained material was analyzed for water content (TG) and by SEM photographs The results are presented in Table 3.

TABLE 3

| | NH₃/ | | | | | | |
|---|---|---|---|---|---|---|---|
| | Fe | | Average | Deviation | | | |
| | mole/ | T | Size | (50%)* | | | |
| Tᵣₑₜ | mole | (° C.) | nm | nm | Habit | Remarks | Product |
| 1 hr | 0.3 | 95 | 69 × 25 | (60-81) × (15-26) | Short | raft-like Aggregates | Fe(OH)₃ |
| | | | | | rods | | |
| 1 hr | 0.59 | 95 | 62 × 14 | (59-65) × (13-16) | sphere | Aggregates of | Fe(OH)₃ |
| | | | | | | 80-200 nm | |
| 1 hr | 1.02 | 95 | 10 | 9-11.0 | sphere | net wise clusters | Fe(OH)₃ |
| 1 hr | 0.3 | 150 | 60 × 18 | (53-68) × (12-20) | rods | uniform aggregates in | |
| | | | | | | size and shape | |
| 1 hr | 0.59 | 150 | 52 × 19 | (48-64) × (15-22) | rods | | |
| 1 hr | 1.02 | 150 | 22 | 18-27 | sphere | | FeOOH |
| 5 days | 0.3 | 95 | 79 × 12 | (70-79) × (9-14) | needles | Clusters of needles | Fe(OH)₃ |
| 5 days | 0.59 | 95 | 37 × 12 | (33-44) × (11-13) | rods | Very uniform small | Fe(OH)₃ |
| | | | | | | rods | |
| 5 days | 0.3 | 150 | 35 | 31-38 | Sphere | Spherical aggregates | |
| | | | | | | of about 100 nm. | |
| 5 days | 1.01 | 150 | | | Sphere | | Fe₂O₃ |
| | 1.02 | 190 | 29 | 22-41 | Sphere | Spherical aggregates | Fe₂O₃ |
| | | | | | | of about 100 nm. | |
| 5 days | 0 | 190 | 11 | 10-14 | Sphere | | Fe₂O₃ |

Deviation (50%)* = the particle size range of 50% of the particles around the average size (nm).

### EXAMPLE 7

100 gr fresh solution of 0.25M Fe₂(SO₄)₃ (about 2.8% iron) was prepared by dissolving Fe₂(SO₄)₃ crystals in water. Weak anion exchanger (Reillex 425™) was added to increase the pH to 2.5. The solution was kept at 25° C. for an hour. The pH reached was 2.0.

The conditions in the solution were adjusted by adding, while vigorously mechanically stirring at 600 rpm to 900 gr water at 80° C., which dilutes, the solution, heats it and increases it pH. After 10 min, the mixing was stopped. Particles were observed. After settling for 1 hour, the clear liquid phase was removed. The precipitate was washed 3 times with water and then centrifuged.

The obtained material was in the form of ultra fine mono-dispersed powder of Fe(OH)₃. SEM photographs indicate that the particle are spherical with uniform particle size of about 40 nm.

It will be evident to those skilled in the art that the invention is not limited to the details of the foregoing illustrative examples and that the present invention may be embodied in other specific forms without departing from the essential attributes thereof, and it is therefore desired that the present embodiments and examples be considered in all respects as illustrative and not restrictive, reference being made to the appended claims, rather than to the foregoing description, and all changes which come within the meaning and range of equivalency of the claims are therefore intended to be embraced therein.

1. A method for the formation of small-size iron oxide particles, comprising the steps of:
a) preparing a fresh starting aqueous solution comprising at least one of ferric ions and complexes thereof, at a concentration of at least 0.1% w/w iron and at a pH greater than about 1.5 and maintaining said freshly prepared solution at a temperature lower than 55° C. for a retention time in which hydrolysis takes place, the extent of said hydrolysis being sufficient to decrease the pH by at least 0.2 units, wherein said time does not exceed 14 days, to form a system containing a modified solution; and
b) adjusting the conditions in said system by at least one of the steps of:
i) heating the modified solution to elevate the temperature thereof by at least 10° C.;
ii) elevating the pH of the modified solution by at least 0.3 units; and
iii) diluting the modified solution by at least 20%;
whereby there are formed particles, wherein the majority of the particles formed are between 2 nm and 500 nm in size.

2. A method according to claim 1, wherein the solution is maintained at said adjusted conditions for at least 0.5 minute.

3. A method according to claim 1, wherein said adjustment of conditions is carried out during less than 1 hour.

4. A method according to claim 1, further characterized in that the majority of the formed particles have a degree of crystallinity of less than 50%.

5. A method according to claim 1, further characterized in that at least 50% of the formed particles are characterized by a size ratio between the smallest and largest particles of less than 10:1.

6. A method according to claim 1 further characterized in that at least 50% of the formed particles are characterized by a size ratio between the smallest and largest particles of less than 5:1.

7. A method according to claim 1, further characterized in that the majority of the formed particles are of a configuration other than elongated.

8. A method according to claim 1, further characterized in that the majority of the formed particles have a surface area of at least 30 m²/gr.

9. A method according to claim 1, further comprising the step of
c) dehydrating said formed particles at a dehydration temperature in a range between 60° C. and 800° C. to form dehydrated particles.

10. A method according to claim 9, wherein said dehydrating is conducted under super-atmospheric pressure.

11. A method according to claim 9, wherein said dehydrating step and said adjusting step are conducted simultaneously.

12. A method according to claim 11, wherein adjusting involves heating to dehydration temperature.

13. A method according to claim 9, further characterized in that the majority of the dehydrated particles are of a configuration other than elongated.

14. A method according to claim 9, further characterized in that the majority of the dehydrated particles have a surface area of at least 30 m²/gr.

15. A method according to claim 12, wherein said particles are selected from the group consisting of goethite, hematite and magnetite.

16. A method according to claim 1, wherein said oxide has the formula of FeOOH.

17. A method according to claim 1, wherein said oxide has the formula Fe(OH)₃.

18. A method according to claim 1, wherein said preparation of an aqueous solution involves at least one of oxidation of metal iron, oxidation of ferrous ions, oxidation of sulfur ions, dissolution of an iron compound and acidulation of an iron salt solution.

19. A method according to claim 18, wherein said oxidation uses an oxidant selected from a group consisting of oxygen, hydrogen peroxide, nitric acid, nitrate and combinations thereof.

20. A method according to claim 18, wherein said oxidation is chemically or biologically catalyzed.

21. A method according to claim 18, wherein said iron compound is selected from the group consisting of iron oxides, iron hydroxides, minerals containing the same and mixtures thereof and wherein said compound is dissolved in an acidic solution comprising an acid selected from the group consisting of sulfuric acid, nitric acid, hydrochloric acid, phosphoric acid, an organic acid, their acidic salts and combinations thereof.

22. A method according to claim 1, wherein said prepared aqueous solution comprises an anion selected from the group consisting of sulfate, chloride, nitrate, phosphate an organic acid and mixtures thereof.

23. A method according to claim 1, wherein the majority of the anions in said prepared starting aqueous solution are sulfate anions.

24. A method according to claim 1, wherein the iron concentration in the prepared solution is greater than 5%.

25. A method according to claim 1, wherein the pH of the solution is less than 6 during at least 80% of the process duration.

26. A method according to claim 1, wherein the pH of the solution in step (a) is kept between 2 and 3 during at least a portion of the maintaining time of step (a).

27. A method according to claim 1, wherein the pH of said aqueous solution is between 1.5 and 4 during at least a portion of the time during which the conditions of the system are adjusted according to step (b).

28. A method according to claim 1, further comprising the step of removing at least part of the water in said particle suspension after said adjusting step (b).

29. A method according to claim 1, comprising at least two heating steps.

30. A method according to claim 1 further comprising at least one of grinding said formed particles and screening said formed particles.

31. A method according to claim 1, further comprising at least partially reducing ferric ions in said formed particles.

32. A method according to claim 1, wherein at least one dispersant is present in at least one step of a group consisting of preparing, keeping, facilitating, dehydrating and grinding

33. A method according to claim 32, wherein said at least one dispersant is selected from a group consisting of cationic polymers, anionic polymers, nonionic polymers, surfactants, and mixtures thereof.

34. A method according to claim 32, further comprising the step of modifying the amount of said at least one dispersant.

35. A method according to claim 1, wherein the solution is treated by at least one of ultrasound and microwaving.

36. Iron oxide particles whenever formed according to the method of claim 1 and products of their conversion.

37. The iron oxide particles of claim 36, characterized in purity with regards to other metals of at least 95%.

38. The iron oxide particles of claim 36, characterized in being of a shape selected from the group consisting of spherical shape, rod shape and raft shape.

39. The iron oxide particles of claim 36, characterized in being doped with atoms of other compounds.

40. A preparation comprising said iron oxide particles whenever prepared according to the method of claim 1;

41. A preparation according to claim 39, wherein said particles are dispersed in a liquid, supported on a solid compound, agglomerated to larger particles, partially fused, coated or a combination thereof.

42. A method for the production of a preparation of claim 40 comprising steps selected from a group consisting of dispersing said particles, addition of a support, heat treatment, mixing, water evaporation spray drying, thermal spraying and a combination thereof.

43. A method comprising using at least one of said particles of claim 36 and said preparations of claim 40 as a pigment.

44. A method comprising using at least one of said particles of claim 36 and said preparations of claim 40 in a catalyst.

45. A method comprising using at least one of said particles of claim 36 and said preparations of claim 40 in a coating.

46. Industrial production of particles according to according to claim 36, wherein particles are formed at a rate of at least 50 Kg/hour.

47. A method for the formation of a pigment, comprising the steps of claim 1.

48. A method for the formation of a catalyst, comprising the steps of claim 1.

49. A method for the formation of small-size iron oxide particles, comprising the steps of:
a) preparing a fresh starting aqueous solution comprising at least one of ferric ions and complexes thereof, at a concentration of at least 0.1% w/w iron, which solution has pH of at least 1.2;
b) preparing a modifying aqueous solution of a temperature greater than 80° C.;
c) contacting the starting solution with the modifying solution in a continuous mode in a mixing chamber to form a modified system;
d) removing the modified system from the mixing chamber in a plug-flow mode, and
which method is characterized in that:
i. the residence time in the mixing chamber is less than about 1 minute,
ii. there are formed particles or aggregates thereof, wherein the majority of the particles formed are between 2 nm and 500 nm in size; and
iii. the formed particles comprise FeOOH, Fe₂O₃, Fe(OH)₃, Fe₃O₄ or a combination thereof.

50. A method according to claim 49, wherein the iron concentration in said starting solution is greater than 2%.

51. A method according to claim 49, wherein at least one of said fresh starting solution and said modifying solution comprise a reagent selected from a group of dispersants and basic compounds.

52. A method according to claim 51, wherein the basic compound is selected from a group consisting of ammonia, ammonium carbonate, ammonium bicarbonate and urea.

53. A method according to claim 51, wherein the OH/Fe molar ratio in the solution of said modified system is less than 3.

54. A method according to claim 51 wherein the OH/Fe molar ratio in the solution of said modified system is between 0.5 and 2.

55. A method according to claim 49, wherein the temperature of the modifying solution is in the range between 100° C. and 300° C.

56. A method according to claim 49, wherein said modified system is retained at a pressure of less than 100 atmospheres.

57. A method according to claim 56, wherein retaining of the modified system is for a duration of between 1 and 30 minutes.

58. A method according to claim 56, wherein during said retaining the temperature is maintained within less than 20° C. from the temperature of the modified system.

59. A method according to claim 49, further comprising a step of retaining the freshly prepared starting aqueous solution before said contacting at a temperature of less than 55° C. and pH greater than 1.5 for a preliminary retention time sufficient for the pH to decrease by at least 0.2 units, wherein said preliminary retention time does not exceed 14 days.

60. A method according to claim 49, where the residence time in the mixing chamber is less than 5 seconds.

61. A method according to claim 49, where the residence time in the mixing chamber is less than 0.5 seconds.

62. A method according to claim 49, wherein the removed modified system is kept for at least 0.5 minutes.

63. Iron oxide particles whenever formed according to the method of claim 49 and products of their conversion.

64. The iron oxide particles of claim 63, characterized in purity with regards to other metals of at least 95%.

65. The iron oxide particles of claim 63, characterized in being of a shape selected from the group consisting of spherical shape, rod shape and raft shape.

66. The iron oxide particles of claim 63, characterized in being doped with atoms of other compounds.

67. A preparation comprising said iron oxide particles whenever prepared according to the method of claim 49.

68. A preparation according to claim 67, wherein said particles are dispersed in a liquid, supported on a solid compound, agglomerated to larger particles, partially fused, coated or a combination thereof.

69. A method according to claim 49, further characterized in that at least 50% of the formed particles are characterized by a size ratio between the smallest and largest particles of less than 10:1.

70. A method according to claim 49 further characterized in that at least 50% of the formed particles are characterized by a size ratio between the smallest and largest particles of less than 5:1.

71. A method according to claim 49, further characterized in that the majority of the formed particles have a surface area of at least 30 m²/gr.
